(19) United States
(12) Patent Application Publication
(10) Pub. No.: US 2010/0043230 A1
(43) Pub. Date: Feb. 25, 2010

(54) Method of Making a Hybrid Metal-Plastic Heat Exchanger

(75) Inventor: Mohinder Singh Bhatti, Williamsville, NY (US)

Correspondence Address: Delphi Technologies, Inc., M/C 480-410-202, PO BOX 5052, Troy, MI, 48007, US

(73) Assignee: DELPHI TECHNOLOGIES, INC., Troy, MI (US)

(21) Appl. No.: 12/336,057

(22) Filed: Dec. 16, 2008

Related U.S. Application Data
(60) Provisional application No. 61/188,702, filed on Aug. 12, 2008.

(51) Int. Cl. B23P 15/26

(52) U.S. Cl. 29/890.046

(57) ABSTRACT

A method of manufacturing a metal-plastic hybrid heat exchanger including the steps of providing a plurality of metallic fins, providing a plastic tank with a melting point above a predetermined temperature and having a header plate that includes a plurality slots, and providing a plurality of plastic tubes with a melting point above the predetermined temperature. The plastic tubes are inserted into the corresponding slots of the plastic tank to form an assembly. The metal fins are inserted between the plastic tubes of the assembly. A thermoplastic adhesive is applied onto the mating surfaces of the metal fins and the plastic tubes, and onto mating surfaces of the slots and the plastic tubes of the assembly. The metal plastic heat exchanger assembly is then heated with infrared radiation to the predetermined temperature to cure the thermoplastic adhesive, thereby bonding the metal fins and the slotted headers to the tubes.

This application claims the benefit of U.S. provisional patent application Ser. No. 61/188,702 for a HYBRID HEAT EXCHANGER AND METHOD OF MAKING THE SAME, filed on Aug. 12, 2008, which is hereby incorporated by reference in its entirety. This claim is made under 35 U.S.C. §119(e); 37 C.F.R. §1.78; and 65 Fed. Reg. 50093.

### TECHNICAL FIELD OF INVENTION

The invention relates to a method of making a heat exchanger; more particularly, a metal-plastic heat exchanger.

### BACKGROUND

Most heat exchangers for high temperature applications are made of metals or ceramics in view of their high melting temperature, high strength and high thermal conductivity needs. For moderate temperature applications, such as for automotive heating and cooling, the heat exchangers are made of metals such as copper and aluminum although they can be made of alternate materials such as thermally conductive plastics. Thermally conductive plastics overcome some undesirable attributes of metals including poor corrosion resistance, high brazing temperature and high manufacturing cost. However, they have their own limitations including low strength, high permeability and low thermal conductivity. Of these shortcomings, lower thermal conductivity had been most difficult to overcome.

Recent developments relating to thermally conductive plastics have overcome this deficiency thereby greatly improving the outlook for plastics as materials of construction for heat exchangers and heat sinks. They are made of thermoplastic materials like fluoropolymers or polyolefins. Typically, they are utilized in applications that are highly corrosive and their operating temperatures are under 300° F. However, these materials do not transfer heat as well as metals and accordingly where the heat transfer rates tend to be low; such as on the air side of compact heat exchangers in automotive heating and cooling applications, their use must be kept to a minimum.

It is desirable to have a method of manufacturing a heat exchanger that allows for a simpler heat exchanger design that can take advantage of thermoplastic and metallic materials to provide for lower material cost, lower manufacturing cost, and energy savings in the manufacturing process

### SUMMARY OF THE INVENTION

The invention relates to a method of manufacturing a metal-plastic hybrid heat exchanger that includes the steps of providing a plurality of metallic fins, providing a plastic tank having a header plate that includes a plurality of slots, and providing a plurality of plastic tubes, in which each tube includes an opened. Each opened end is inserted into the corresponding slot of the plastic tank to form an assembly. The metal fins are then inserted between the plastic tubes of the assembly. A thermoplastic adhesive is applied onto the mating surfaces of the metal fins and the plastic tubes, and onto mating surfaces of the slots and the plastic tubes of the assembly. The assembly is then heated with infrared radiation to the predetermined temperature to cure the thermoplastic adhesive, thereby bonding the metal fins and the slotted headers to the tubes.

The metal-plastic hybrid heat exchanger can take advantage of the recently developed thermally conductive high strength plastic materials such as liquid crystal polymers (LCP) with graphite fibers and ceramic filler.

The benefits of this method of manufacturing a hybrid plastic and metal heat exchanger includes a simpler heat exchanger design, lower material cost, lower manufacturing cost, and energy savings in the manufacturing process. Further features and advantages of the invention will appear more clearly on a reading of the following detailed description of an embodiment of the invention, which is given by way of non-limiting example only and with reference to the accompanying drawings.

### BRIEF DESCRIPTION OF DRAWINGS

This invention will be further described with reference to the accompanying drawing in which:

FIG. 1 is an exploded view of a metal-plastic hybrid heat exchanger.

### DETAILED DESCRIPTION OF INVENTION

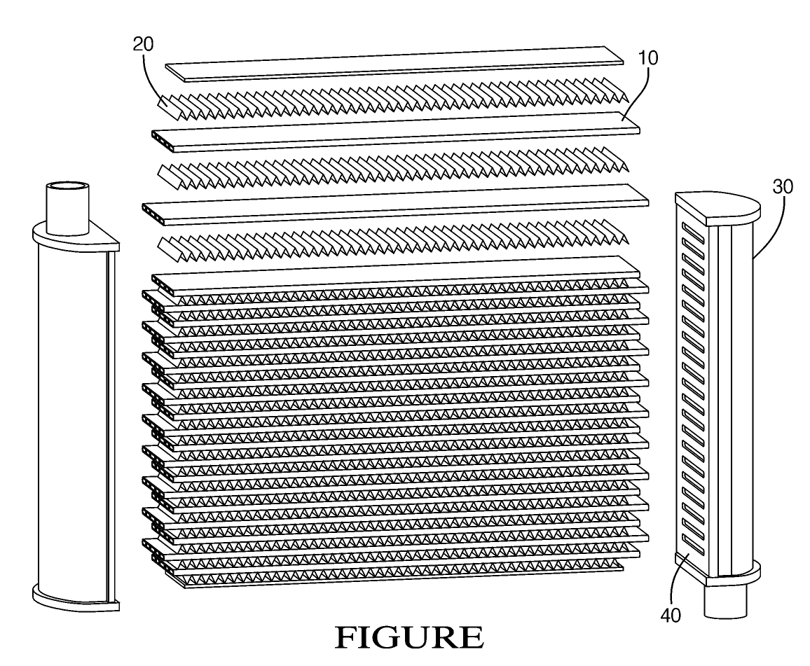

Shown in FIG. 1 is a metal-plastic hybrid heat exchanger that includes a plurality of plastic tubes 10, metal fins 20, plastic tanks 30 and plastic headers 40. Presented below are the design considerations in the selection of these materials as well as in the method of bonding the metal fins 20 and plastic headers 40 to the plastic tubes 10.

### Selection of Plastic Tubes

Selection of the plastic tubes 10 is dictated by the desire to improve the corrosion resistance on the coolant side of the heat exchanger and to reduce the material cost of the heat exchanger. Since the thermal conductivity and the tensile strength of the conventional plastics are lower than those of metal, it is desirable that new plastic materials with improved strength and thermal conductivity be used. The tensile strength of the new plastic materials is comparable with that of aluminum suggesting that reasonably thin-walled plastic tubes 10 can be employed. However, the thermal conductivity of the new plastic material is still low being about 0.1 time that of metals. This means that the thermal resistance R_{w} of the plastic tube of the same thickness δ_{w} and the same tube wall area A_{w} as the metal tube wall will be higher by a factor of 10 as can be seen from the relation

$${R}_{w} = \frac{{δ}_{w}}{{κ}_{w} {A}_{w}} \qquad ( 1 )$$

where κ_{w} is the thermal conductivity of the wall material.

In metal heat exchanger cores the tube wall resistance R_{w} is relatively low compared to the air side thermal resistance Rₐ and the coolant side thermal resistance R_{c}. A ten-fold increase in R_{w} can adversely affect the heat transfer rate as can be inferred from the following heat transfer rate \dot{q} equation analogous to Ohms law:

$$\dot{q} = \frac{Δ T}{{R}_{t}} = \frac{Δ T}{{R}_{a} + {R}_{w} + {R}_{c}} \qquad ( 2 )$$

where ΔT is the difference between the mean temperature of air and mean temperature of coolant and Rₜ is the total thermal resistance of the heat exchanger being the sum of R_{a,}R_{w} and R_{c}. The air side thermal resistance Rₐ and the coolant side thermal resistance R_{c} are given as

$$\begin{matrix}{R}_{a} = \frac{1}{{h}_{a} {A}_{a}} & ( 3 ) \\ {R}_{c} = \frac{1}{{h}_{c} {A}_{c}} & ( 4 )\end{matrix}$$

where hₐ is the air side heat transfer coefficient, Aₐ is the effective air side heat transfer area including the area of the air side fins 20 (if any), h_{c} is the coolant side heat transfer coefficient and A_{c} is the effective coolant side heat transfer area including the area of the coolant side fins (if any). Aₐ and A_{c} are expressible as

Aₐ=Aₚₐ−A_{fa}(1−η_{fa}) (5)

A_{c}=A_{pc}−A_{fc}(1−η_{fc}) (6)

where Aₚₐ is the prime surface area on the air side, A_{fa} is the fin surface area on the air side, η_{fa} is the fin temperature effectiveness on the air side, A_{pc} is the prime surface area on the coolant side, A_{fc} is the fin surface area on the coolant side and η_{fc} is the fin temperature effectiveness on the coolant side.

For the metal heat exchangers of the type used in present day automotive applications, the approximate values of the three thermal resistances are R_{w}/Rₜ=0.005, R_{c}/Rₜ=0.10 and Rₐ/Rₜ=0.895. It is apparent from these values that with a ten-fold decrease in κ_{w} the plastic tube wall thermal resistance could become significant fraction of the total thermal resistance. Given the relatively low value of the thermal conductivity of the available new plastic material, the one way to keep R_{w} at a manageable level is to increase the tube wall area A_{w}. This can be achieved by providing more tubes 10 and shorter air side fins 20 (i.e., fins with lower value of the fin length l along which heat is conducted), which inherently are more effective.

Another consideration involved in reducing the coolant side thermal resistance R_{c} is to increase the coolant side heat transfer coefficient h_{c}. This is achievable by using multi-port coolant tubes 10 with small hydraulic diameter of the coolant flow passages.

Non-Linear Relationship between Thermal Conductivity of a Solid and Heat Dissipation Rate from its Surface

The thermal conductivity of the commonly used aluminum alloys in heat exchanger construction is about 200 Wm⁻¹K⁻¹ while that of the commercially available thermally conductive plastics like LCP is about 20 Wm⁻¹K⁻¹. Notwithstanding an order of magnitude lower thermal conductivity, it is possible to design a plastic heat exchanger capable of delivering the same thermal performance as the aluminum alloy heat exchanger. This is possible because the thermal performance of a heat exchanger is design rather than material-limited. From a heat transfer point of view, this is tantamount to saying that the thermal performance of a heat exchanger is convection-limited rather than conduction-limited. The heat dissipation from the surface of a heat exchanger is primarily controlled by convection, which is insensitive to the thermal conductivity of the heat exchanger material. Augmentation of the convective heat transfer in a heat exchanger is at designer's disposal. There are several ways to augment the convective heat transfer coefficient such as use of forced convection as opposed to natural convection, use of extended surfaces in the form of fins 20 bonded to the prime surface of the heat exchanger and use of cooling medium with higher heat capacity, e.g., water as opposed to air. The internal heat transfer through the thickness of the heat exchanger material, on the other hand, is primarily controlled by conduction, which is directly proportional to thermal conductivity of the material.

The internal heat transfer rate \dot{q}_{cond} within the solid walls of a heat exchanger is governed by Fourier's law of heat conduction:

$${\dot{q}}_{cond} = \frac{κ}{δ} A ( {T}_{i} - {T}_{s} ) \qquad ( 7 )$$

where κ is the thermal conductivity of the solid, A the heat transfer area across which heat is conducted, δ the thickness of the solid, Tᵢ the temperature at which the heat source is applied to the solid and Tₛ the temperature at the solid surface away from the heat source.

In analogy with the convective heat transfer coefficient h (vide infra), κ/δ in Eq. (7) may be viewed as conductive heat transfer coefficient since it has the dimensions of the convective heat transfer coefficient h and it plays the same role in heat conduction as h does in heat convection.

The external heat transfer rate \dot{q}_{conv} from the heat exchanger surface is governed by convective heat transfer rate equation:

\dot{q}_{conv}=hA(Tₛ−Tₐ) (8)

where in addition to the previously defined symbols, h is the convective heat transfer coefficient and Tₐ is the temperature of the cooling medium on the solid surface. Among other factors, h depends on the thermal conductivity of the cooling medium, but not on the thermal conductivity κ of the solid.

The radiative heat transfer rate \dot{q}_{rad} from a solid surface is given by the Stefan-Boltzmann law:

\dot{q}_{rad}=σεA(Tₛ⁴−Tₐ⁴) (9)

where in addition to the previously defined symbols, σ=5.67×10⁻¹⁶ Wm⁻² K⁻⁴ is the Stefan-Boltzmann constant and ε is the emissivity of the radiating surface.

With the introduction of the radiative heat transfer coefficient h_{rad} defined as

h_{rad}=σε(Tₛ+Tₐ)(Tₛ²+Tₐ²) (10)

Eq. (9) can be expressed as

\dot{q}_{rad}=h_{rad}A(Tₛ−Tₐ) (11)

which is analogous to Eqs. (7) and (8).

It is evident from Eq. (11) that like the convective heat transfer coefficient h the radiative heat transfer coefficient h_{rad} is not dependent on the thermal conductivity of the solid.

At relatively low temperatures Tₛ of the order of several hundred degrees C encountered in most heat exchanger applications, the value of the radiative heat transfer coefficient h_{rad} defined in Eq. (10) is appreciably lower than the value of the convective heat transfer coefficient h. For example, at Tₛ=473 K, Tₐ=298 K, the value of h_{rad}=6.79×10⁻⁹ W/m²K for pure aluminum with ε =0.05 as provided for in H. C. Hottel and A. F. Sarofim, Radiative Transfer, pp. 159-168, McGraw Hill Book Company, New York, 1967.

Under similar temperature conditions, the value of the convective heat transfer coefficient h is on the order of 1 to 10 Wm⁻²K⁻¹. Consequently, in most practical moderate to low temperature applications the external radiative heat transfer rate \dot{q}_{rad} is neglected compared to the external convective heat transfer rate \dot{q}_{conv}. In such cases, the internal heat transfer is by conduction and the external heat transfer is by convection.

A comparison of Eqs. (7) and (8) reveals that if κ/δ is equal to h the internal and external heat transfer rates become comparable and the relationship between the thermal conductivity κ and the external heat transfer rate becomes linear. However, it turns out that h is generally much smaller than κ/δ and consequently the external heat transfer rate \dot{q}_{conv} given in Eq. (8) is smaller than the internal heat transfer rate \dot{q}_{cond} given in Eq. (7) resulting in non-linear relationship between \dot{q}_{conv} and κ depicted in Graph 1.

The generic curve in Graph 1 is applicable to any solid with internal heat transfer by conduction and external heat transfer by convection. The shape of the curve in Graph 1 is the same regardless of the application. The quantitative values on the axes are not shown because they depend on the power, part size and convective cooling conditions. They become fixed for any given application and set of conditions. It is obvious from the shape of the curve that heat transfer depends on material thermal conductivity up to a point—the knee in the curve, beyond which increasing thermal conductivity produces negligible improvement in the heat transfer. Thus the high thermal conductivity of a solid is often wasted if the external convective heat transfer coefficients at its surface are low.

### NUMERICAL EXAMPLE ILLUSTRATING DEPENDENCE OF THERMAL PERFORMANCE OF A HEAT EXCHANGER ON THE DESIGN AND NOT ON THE MATERIAL OF CONSTRUCTION

The thermal performance of a heat exchanger in general is design-limited rather than material-limited. From a heat transfer point of view, this is tantamount to saying that the thermal performance of a heat exchanger is convection-limited rather than conduction-limited since the heat dissipation from the surface of a heat exchanger is primarily controlled by convection, which is insensitive to the thermal conductivity of the heat exchanger material. To illustrate this point, let us consider a 75×75×3 mm flat plate with a 5 W heater, with 50° C. surface temperature attached to the underside of the plate. Let the plate be made of four different materials—conventional plastic with thermal conductivity 0.25 Wm⁻¹K⁻¹, thermally conductive plastic with thermal conductivity 25 Wm⁻¹K⁻¹, aluminum with thermal conductivity 231 Wm⁻¹K⁻¹ and copper with thermal conductivity 391 Wm⁻¹K⁻¹. Let the plate be placed in a horizontal position in air at 25° C. where it cools by natural convection. It is required to determine the rate of dissipation of heat from the surface of the plate away from the heat source by natural convection and compare it with the rate of heat transfer by conduction through the plate material with varying thermal conductivity.

As a prelude to the determination of the heat dissipation rate from Eq. (8), we must first determine the surface temperature Tₛ using Eq. (7). By the problem statement, we have \dot{q}_{cond}=5 W, κ=0.25, 25, 231, 391 Wm⁻¹K⁻¹ for the four materials, δ=0.003 m, A=0.075×0.075 m² and Tᵢ=50° C. Introducing these values into Eq. (7), we obtain the following values of the surface temperature away from the heat source for the four materials: Tₛ=39.3333, 49.8933, 49.9885, 49.9932° C.=312.3333, 322.8933, 322.9885, 322.9932 K corresponding to κ=0.25, 25, 231, 391 Wm⁻¹K⁻¹.

Next we direct our attention to the determination of the mean convective heat transfer coefficient h. The natural convection mean heat transfer coefficient h for a horizontal plate with uniform heat flux is given by Y. Jaluria, Natural Convection Heat and Mass Transfer, p. 83, Pergamon Press, New York, 1980, as:

$$Nu ≡ \frac{hL}{{κ}_{a}} = 0.8355 {Gr}^{1 / 5} {Pr}^{1 / 4} \qquad ( 12 )$$

where
Nu is the dimensionless mean Nusselt number defined in Eq. (12)
L is the characteristic dimension of the plate
κₐ is the thermal conductivity of the cooling medium
Pr is the dimensionless Prantle number of the cooling medium
Gr is the dimensionless Grashoff number defined as

$$Gr = \frac{β {gL}^{3} ( {T}_{s} - {T}_{a} )}{{v}^{2}} \qquad ( 13 )$$

where in addition to the previously symbols
g is the acceleration due to gravity=9.81 ms⁻²
v is the kinematic viscosity of the cooling medium
β is the coefficient of thermal expansion of the cooling medium defined below

$$β = \frac{{ρ}_{a} - {ρ}_{s}}{{ρ}_{s} ( {T}_{s} - {T}_{a} )} \qquad ( 14 )$$

where in addition to the previously defined symbols
ρₐ is the density of the cooling medium at Tₐ
ρₛ is the density of the cooling medium at Tₛ

For an ideal gas, the densities of the cooling medium at Tₐ and Tₛ can be expressed as ρₐ=P/RTₐ and ρₛ=P/RTₛ where P is the pressure and R the gas constant of the cooling medium. Introducing these relations into Eq. (14), the coefficient of thermal expansion of the ideal gas cooling medium simply becomes β=1/Tₛ.

Knowing the calculated values of Tₛ=312.3333, 322.8933, 322.9885, 322.9932 K, we at once obtain the values of β=1/Tₛ=0.003202, 0.003097, 0.003096, 0.003096 K⁻¹. Using these values of β together with g=9.81 ms⁻², v=1.5747×10⁻⁵ m²s⁻for air, L=0.075 m and the prescribed value of Tₐ=25° C.=298 K, we obtain from Eq. (13) Gr=766,004; 1,286,888; 1,291,888; 1,291,888 corresponding to κ=0.25, 25, 231, 391 Wm⁻¹K⁻¹.

Knowing the values of Gr and Pr=0.7085 for air, we obtain from Eq. (12), Nu=11.5176, 12.7768, 12.7876, 12.7867 corresponding to κ=0.25, 25, 231, 391 Wm⁻¹K⁻¹. Next knowing Nu together with Kₐ=0.0261 Wm⁻K⁻¹ for air and L=0.075 m, we obtain from the defining relation for Nu in Eq. (12) h=4.0081, 4.4463, 4.4998, 4.4998 Wm⁻²K⁻¹ corresponding to κ=0.25, 25, 231, 391 Wm⁻¹K⁻¹.

Finally, substituting the calculated values of h and Tₛ together with the prescribed values of A and Tₐ, we obtain from Eq. (8), the heat dissipation rate by natural convection from the surface of the plate away from the heat source as \dot{q}_{conv}=0.3683, 0.6726, 0.6755, 0.6755 W.

Comparing the external heat transfer rate as \dot{q}_{conv}=0.3683, 0.6726, 0.6755, 0.6755 W corresponding to κ=0.25, 25, 231, 391 Wm⁻¹K⁻¹ with the internal heat transfer rate \dot{q}_{cond}=5 W, we notice that the external heat dissipation rate is 7 to 13 times lower than the internal heat transfer rate. Furthermore, we notice that the initial increase in the thermal conductivity by a factor of 100 results in a significant increase in the external heat dissipation rate, but a further increase in the thermal conductivity by a factor of 10 results in insignificant gain in the heat dissipation rate. Any further gain in the heat dissipation rate can be achieved by an increase in the heat transfer coefficient, which does not depend on thermal conductivity of the heat exchanger material, but is at designer's disposal. It can be increased by changing the external cooling medium or by changing the external mode of heat transfer from natural convection to forced convection. The forced convection heat transfer coefficient could be 10-15 times higher than the natural convection heat transfer coefficient. Yet another way of changing the external heat dissipation rate at designer's disposal is to increase the external heat transfer area by adding fins 20 to the primary heat transfer surface.

### Selection of Metal Fins Over Plastic Fins

A distinguishing feature of the metal heat exchangers using air as the heat transfer medium is that they invariably employ metal fins 20 to reduce the thermal resistance on the air side. The plastic heat exchangers, on the other hand, generally do not employ plastic fins on the air side as the plastic fins are ineffective in reducing the thermal resistance of the air side. The explanation of the ineffectiveness of the plastic fins to reduce the air side thermal resistance can be provided in terms of the dimensionless fin temperature effectiveness η_{f} which is a measure of how effectively a non-isothermal fin conducts heat compared to the isothermal prime surface, i.e., the surface in direct contact with the heat source whence the heat is to be dissipated. As provided in W. M. Kays and A. L. London, Compact Heat Exchangers, Third Edition, McGraw-Hill Book Company, New York, pp. 15-16, 1984, the dimensionless fin temperature effectiveness η_{f} for a thin sheet fin is expressible in terms of a dimensionless fin parameter (2h/κ_{f}δ_{f})^{1/2}l as:

$${η}_{f} = \frac{{tanh ( 2 h / {κ}_{f} {δ}_{f} )}^{1 / 2} l}{{( 2 h / {κ}_{f} {δ}_{f} )}^{1 / 2} l} \qquad ( 15 )$$

where h is the heat transfer coefficient of fluid surrounding the fin, κ_{f} is the thermal conductivity of the fin material, δ_{f} is the fin thickness and l is the fin length along which heat is conducted. When the fin extends from wall-to-wall, the effective fin length is half the wall spacing.

Variation of the dimensionless fin temperature effectiveness η_{f} for a thin sheet fin with the dimensionless fin parameter (2h/κ_{f}δ_{f})^{1/2}l is graphically presented in Graph 2.

It is seen from Graph 2 that at one end of the spectrum

$${lim}_{{( 2 k / {k}_{f} {δ}_{f} )}^{1 / 2} l 0} {η}_{f} = 1 for conductive metallic fins \qquad ( 16 )$$

while at other end of the spectrum

$${lim}_{{( 2 k / {k}_{f} {δ}_{f} )}^{1 / 2} l > 10} {η}_{f} = 0 for non \text{-} conductive plastic fins \qquad ( 17 )$$

By way of a concrete example, let us calculate the fin temperature effectiveness η_{f} for a convoluted louvered fin used in automotive heat exchangers such radiators, heaters, condenser and evaporators. Let the fin be made of three different types of materials—conventional plastic with κ_{f}=0.25 Wm⁻¹K⁻¹, thermally conductive plastic with κ_{f}=25 Wm⁻¹K⁻¹ and metal with κ_{f}=250 Wm⁻¹K⁻¹. The typical value of the convective heat transfer coefficient h in the automotive heat exchangers with air as the cooling medium is 60 Wm⁻²K⁻¹. Also the typical values of the fin thickness δ_{f} and the fin length l are 0.0762 mm and 10 mm respectively.

Using the foregoing numerical values, we obtain (2h /κ_{f}δ_{f})^{1/2}=25.0982, 2.5098, 0.7937 corresponding to κ_{f}=0.25, 25, 250 Wm⁻¹K⁻. Introducing these values of (2h/κ_{f}δ_{f})^{1/2} into Eq. (15), we obtain η_{f}=0.0398, 0.3932, 0.8322 corresponding to κ_{f}=0.25, 25, 250 Wm⁻¹K⁻¹. These results show that the fin effectiveness of the conventional plastics is extremely poor. For the thermally conductive fins, the fin effectiveness is considerably improved, but it is still significantly lower than that of the metal fins 20. Therefore, use of the plastic fins on the air side of the metal-plastic hybrid heat exchanger is ruled out in favor of the metal fins 20.

### Selection of Plastic Tanks and Headers

Metal heat exchangers generally employ slotted metal headers and plastic tanks 30 since the metal headers can be readily brazed to metal tubes and the plastic tanks 30 can be readily clinched on the brazed metal headers. Since no metal brazing operation is involved in the fabrication of the metal-plastic hybrid heat exchanger, it is possible to use slotted headers made of lower cost conventional plastic material like nylon 66 with 25% fiberglass loading. What is more, the tank and the slotted header can be fabricated as a single-piece unit by injection molding process so as to simplify the heat exchanger construction thereby realizing cost savings.

### Bonding of Metal and Plastic Parts

Bonding of the metal fins 20 and the plastic headers 40 to the plastic tubes 10 requires an adhesive which can form adherent bonds between plastic and metallic materials as well as between two plastic materials. Such materials are ionomers, which can be applied as a sheath to the external surface of the plastic tube by coextrusion. After the heat exchanger core complete with fins 20 and headers 40 is assembled the necessary bonds between the fins 20 and the tubes 10 on one hand and between the headers 40 and the tubes 10 on the other can be readily formed by low temperature fusion of the ionomer sheath in an infrared curing oven.

### Metal-Plastic Hybrid Heat Exchanger

FIG. 1 shows the metal-plastic hybrid heat exchanger of the present invention comprising aluminum fins 20 on the air side and multi-port flat tubes 10 made of plastic on the coolant side based on the foregoing design considerations. The multi-port plastic tubes 10 are made of highly conductive plastic reinforced with non metal particles to provide high strength and high thermal conductivity. Because of relatively low thermal conductivity and permeability of plastics compared to metals, it is desirable that the tube wall be as thin as possible and yet be able to withstand the fluid pressure inside the tube. Such thin-walled multi-port tubes 10 can be made by the extrusion process with a coextruded layer of vapor barrier in the tube interior if required. Use of the convoluted metal fins 20 serves a two-fold purpose. It reinforces the thin-walled plastic tubes 10 and reduces the thermal resistance on the air side. The slotted header and coolant tank can be made of conventional plastic material as a single-piece unit by injection molding to ensure that the heat exchanger is leak-free and to reduce its manufacturing cost.

The convoluted metal fins 20 can be bonded to the plastic tubes 10 by means of an ionomer, which is an ion containing copolymer containing nonionic repeat units and a small amount (less than 15%) of ionic containing repeat units. Because of the presence of electrically charged ions, the ionomers are capable of forming a strong adherent bond between a metal and a plastic as well as between two plastic materials. Ionomers are not crosslinked polymers, but are in fact a type of thermoplastic elastomer. When heated the ionic groups in the ionomer lose some of their attraction for each other allowing nonpolar polymer backbone chains to move around freely facilitating formation of the bond between dissimilar materials like plastics and metals.

An example of a commercially available ionomer is the DuPont product called Surlyn, which was introduced in the early 1960s. Many of its applications are in the packaging industry, e.g., candy wrap with aluminum foil on one side and plastic film on the other illustrating bonding of metal to plastic. Another well known application of Surlyn is its use in the outer covering of golf balls illustrating bonding of two plastic materials.

Surlyn is available as a resin, foam, film or sheet. It can also be coextruded as a sheath on the external surface of a plastic tube. The potential use of the coextruded Surlyn sheath on the plastic tubes 10 to bond the metal fins 20 onto the plastic tubes 10 and the plastic headers 40 to the plastic tubes 10 is deemed to be a novel application of the ionomer. Chemically, Surlyn is a sodium salt formed by polymerizing ethylene with a small amount of methacrylic acid and then neutralizing the resulting polyethylene-co-methacylic acid with sodium hydroxide as depicted by the following chemical reaction:

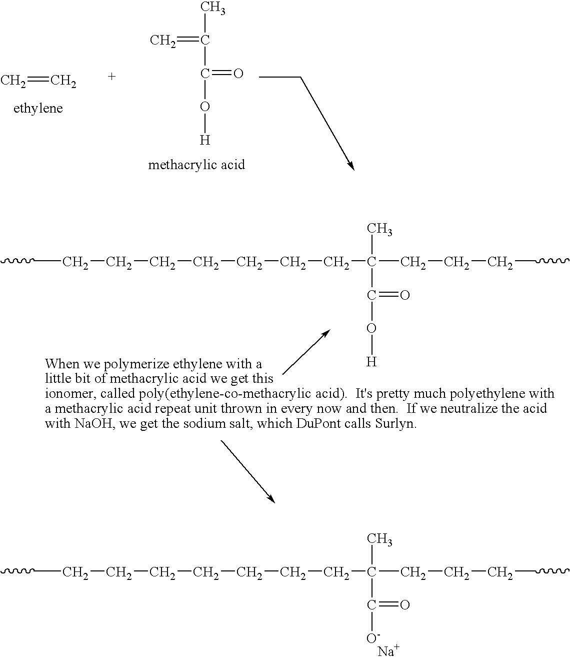

The tank-header assembly can be made of conventional plastic materials like nylon, but the tubes have to be made of special thermally conductive and strong plastic materials. A thermally conductive plastic material suitable for the plastic tubes 10 of interest is a liquid crystal polymer (LCP) whose mechanical and thermal properties are given in Table 1 below and compared with those of conventional nylon 66, aluminum alloy 3003 (comprising 0.12% Cu and 1.2% Mn) used in heat exchanger construction, pure aluminum and pure copper. The properties of LCP in Table 1 are taken from reference J. Ogando, “And now—an Injection-Molded Heat Exchanger,” published in Design News Material, U.S. Design News, Nov. 1, 2000. Those for metals in annealed condition from reference Metals Handbook, 9^{th} Edition, Volume 2, pp. 63 and 275, American Society for Metals, Metals Park, Ohio, 1979.

A comparison of the properties in Table 1 shows that the ultimate tensile strength of LCP is comparable with that of 3003 alloy, but superior to that of pure aluminum and inferior to that of pure copper. The elongation of LCP is negligible compared to those of other materials listed in Table 1. The modulus of elasticity of LCP is about one third that of pure copper, but half that of pure aluminum and aluminum alloy 3003. The thermal conductivity of LCP is 10% that of the aluminum alloy 3003, 9% that of aluminum and 5% that of copper. Included in Table 1 are the heat deflection or heat distortion temperature (HDT) values for the plastic material. HDT is the temperature at which a polymer or plastic sample deforms under a specified load. This property of a plastic material is applied in many aspects of product design, engineering and manufacture of products using thermoplastic components. A comparison of the properties of the two plastic materials shows except for the elongation all other properties of LCP are superior to those of nylon 66.

TABLE 1
Comparison of the Room Temperature Mechanical and
Thermal Properties of Various Materials

| | | | Aluminum | Pure | Pure |
|---|---|---|---|---|---|
| Property | Nylon 66 | LCP | Alloy 3003 | Aluminum | Copper |
| Tensile | 5.8 | 16.1 | 16.0 | 11.0 | 34.0 |
| strength, | | | | | |
| ksi | | | | | |
| Elonga- | 90 | 0.9 | 35 | 39 | 45 |
| tion, % | | | | | |
| Modulus | 0.5 × 10³ | 5.4 × 10³ | 10 × 10³ | 10 × 10³ | 17 × 10³ |
| of | | | | | |
| elasticity, | | | | | |
| ksi | | | | | |
| Thermal | 0.25 | 20 | 193 | 231 | 391 |
| con- | | | | | |
| ductivity, | | | | | |
| Wm⁻¹K⁻¹ | | | | | |
| HDT at | 212 | 530 | — | — | — |
| 264 | | | | | |
| psi, ° F. | | | | | |

The bonding of the plastic headers 40 and metal fins 20 to plastic tubes 10 via the intervening ionomer layer is preferentially achieved by low temperature infrared heating. Infrared heating refers to heating objects through electromagnetic radiation. Within the electromagnetic spectrum the infrared radiation band starts at 0.70 μm and extends to 1000 μm, although the useful range of wavelengths for infrared heating applications occurs between 0.70 μm to 10 μm. The amount of infrared radiation absorbed by carbon dioxide, water vapor and other particles in the air is negligible. As such the infrared radiation travels through air without heating it. The infrared radiation gets absorbed or reflected by objects it strikes. The temperature of the object struck by the infrared radiation as well as the wavelength of the radiation emitted by the object depends on the properties of the object material. Infrared heating is popular in industrial manufacturing processes, e.g., curing of coatings, forming of plastics, annealing and plastic welding. In these applications, infrared heaters replace convection ovens and contact heating. If the wavelength of the infrared heater is matched to the absorption characteristics of the material, significant gains in energy efficiency are possible.

### Comparison of all Metal, all Plastic and Metal-Plastic Hybrid Heat Exchanger

The design and performance of the metal-plastic hybrid heat exchanger core differs in many respects from the design of an all metal as well as an all plastic heat exchanger core. The plastic material used in the design of the all plastic and hybrid heat exchanger was chosen to be nylon for the purposes of this comparison. The significant structural and performance differences among all metal, all plastic and metal plastic heat exchanger cores are brought out in Table 2 for identical heat transfer rate, air side pressure drop, air flow rate, coolant flow rate, core height and core width. The plastic material employed in the design of all plastic and hybrid heat exchanger is Nylon 66 while the metallic material employed in the design of the all metal and hybrid heat exchanger is aluminum alloy 3003 containing 0.12% Cu and 1.2% Mn. With substitution of Nylon 66 with a new thermally conductive plastic such as LCP the outlook for the plastic as well as the hybrid heat exchanger will improve.

TABLE 2
Comparison of Metal, Plastic and Metal-Plastic
Hybrid Heat Exchanger Cores

| | Aluminum | Plastic | Hybrid |
|---|---|---|---|
| Heat transfer rate, Btu/min | 1,648 | 1,648 | 1,648 |
| Air pressure drop, in H₂O | 0.30 | 0.30 | 0.30 |
| Coolant pressure drop, psi | 0.8 | 1.0 | 2.3 |
| Airflow rate, lbₘ/min ft² | 60 | 60 | 60 |
| Coolant flow rate, GPM | 20 | 20 | 20 |
| Core height, in. | 14.2 | 14.2 | 14.2 |
| Core width, in. | 23.6 | 23.6 | 23.6 |
| Core depth, in. | 0.63 | 1.58 | 1.10 |
| Fin density, fpi | 20 | 0 | 15 |
| Airside hydraulic dia, in. | 0.080 | 0.088 | 0.071 |
| Tube hydraulic dia., in. | 0.133 | 0.020 | 0.020 |
| Number of tubes | 32 | 187 | 120 |
| Fin area, ft² | 46.4 | 0 | 60.8 |
| Tube area, ft² | 6.8 | 97.3 | 46.4 |
| Total area, ft² | 53.2 | 97.3 | 107.2 |
| Fin mass, lbₘ | 1.05 | 0 | 1.31 |
| Tube mass, lbₘ | 1.27 | 3.47 | 1.55 |
| Total mass, lbₘ | 2.32 | 3.47 | 2.86 |

Several useful conclusions can be drawn from the tabular comparison of all metal, all plastic and metal-plastic hybrid heat exchanger cores. The following differences are apparent for identical heat transfer rate, air side pressure drop, air flow rate, coolant flow rate, core height, and core width:
1. Coolant side pressure drop is the highest for the hybrid core and the lowest for the metal core.
2. The core depth is the highest for the plastic core and the lowest for the metal core.
3. The fin density is the highest for the metal core and the lowest for plastic core.
4. The air side hydraulic diameter of the flow passage is the smallest for the hybrid core and the largest for the plastic core.
5. The coolant side hydraulic diameter of the tube is larger for the metal core (since there are ports within the metal tube) than those for the plastic and hybrid core since the plastic tube is a multi-port tube.
6. The number of coolant tubes is the largest for the plastic core and the smallest for the metal core. This was dictated by the desire to reduce the thermal resistance of the tube wall. This also implies that for a given face area of the core the fin length along which heat is conducted is the shortest for the plastic core. Since the temperature effectiveness of a shorter fin is higher, the plastic core has an advantage over the metal core on this count.
7. The plastic core is finless as plastic fins are ineffective in reducing the air side thermal resistance. The fin surface area is larger for the hybrid core than that for the metal core since the hybrid core depth is larger than the metal core depth.
8. The tube surface area is by far the largest for the plastic core and the smallest for the metal core since larger tube surface is necessary to reduce the wall thermal resistance of the plastic tubes 10.
9. The total heat transfer area is the largest for the hybrid core and the smallest for the smallest for the metal core. This is dictated by the desire to manage the tube wall thermal resistance.
10. The plastic core is finless. Since the hybrid core has larger depth its fin mass is larger than that of the metal core despite lower fin density and shorter fin length for the hybrid core fin.
11. The tube mass is the smallest for the metal core and the largest for the plastic core. This is because tube mass is the mass of the prime surface and the plastic core needs to have all prime surface.
12. The total core mass is the smallest for metal core and largest for the plastic core due to the necessity to provide more prime surface for plastic core.

The main advantages of the metal-plastic hybrid heat exchangers are energy savings in manufacturing, lower manufacturing cost due to simpler construction, lower material costs and less environmental pollution in the manufacturing operations. The material costs for the hybrid heat exchanger are lower than those of the metal heat exchanger. The bonding temperature of the hybrid heat exchanger is significantly lower than the brazing temperature of the metal heat exchanger resulting in energy savings in the manufacturing process. There are significant savings due to elimination of high temperature brazing furnaces, flux and protective nitrogen atmosphere required in the fabrication of the metal heat exchanger. The environmental pollution stemming from the manufacturing process is lower due to lower curing temperature and absence of flux. The overall manufacturing cost of the hybrid heat exchanger is lower due to simpler construction, energy savings and reduction in capital investment. The corrosion resistance of the hybrid exchanger is superior to that of the metal heat exchanger leading to longer life and reliability of the heat exchanger. Significant cost savings result from forming the slotted header and tank as a single-piece unit by injection molding.

We claim:

1. A method of manufacturing a metal-plastic hybrid heat exchanger comprising the steps of:
providing a plurality of metallic fins;
providing a plastic tank with a melting point above a predetermined temperature and having a header plate that includes a plurality slots;
providing a plurality of plastic tubes with a melting point above the predetermined temperature, wherein each of said plastic tubes include an opened end adapted to be insert into one of said slots;
inserting said opened ends of said plastic tubes into corresponding said slots of said plastic tank to form an assembly;
inserting said metal fins between said plastic tubes of said assembly; and
applying a thermoplastic adhesive onto mating surfaces of said metal fins and said plastic tubes, and onto mating surfaces of said slots and said plastic tubes of said assembly; and
heating said assembly with infrared radiation to the predetermined temperature to cure said thermoplastic adhesive, thereby bonding said metal fins and said slotted headers to said tubes.

2. The method of manufacturing a metal-plastic hybrid heat exchanger of claim 1, wherein said thermoplastic adhesive comprises an ionomer.

3. The method of manufacturing a metal-plastic hybrid heat exchanger of claim 2, wherein said ionomer includes an ion having a copolymer containing nonionic repeat units and less than 15% of ionic containing repeat units.

4. The method of manufacturing a metal-plastic hybrid heat exchanger of claim 3, wherein said predetermined temperature is 400° F.

5. The method of manufacturing a metal-plastic hybrid heat exchanger of claim 1, further includes the step reinforcing said plurality of said plastic tubes with a metallic material selected from a group consisting of Al, Cu, and Mn.

6. The method of manufacturing a metal-plastic hybrid heat exchanger of claim 6, wherein the step of said providing said plastic tubes includes,
providing a liquid crystal polymer, and
extruding said liquid crystal polymer to form said plastic tubes.

7. The method of manufacturing a metal-plastic hybrid heat exchanger of claim 1, wherein the step of said providing plastic tank includes,
providing a plastic resin selected from a group consisting of nylons, fluoropolymers, and polyolefins, and
injection molding said plastic resin to form said plastic tank.

8. The method of manufacturing a metal-plastic hybrid heat exchanger of claim 7, wherein said plastic tank includes nylon 66 and fiberglass.

9. The method of manufacturing a metal-plastic hybrid heat exchanger of claim 2, wherein each of said plurality of said plastic tubes includes an external surface, and further includes the step of co-extruding a sheath of said ionomers onto said external surface.

10. A method of manufacturing a metal-plastic hybrid heat exchanger comprising the steps of:
providing a plurality of convoluted metallic fins;
providing a plastic resin selected from a group consisting of nylons, fluoropolymers, and polyolefins, wherein said plastic resin has a melting point greater than 400° F.,
molding said plastic resin into a plastic tank having a header plate that includes a plurality of slots;
providing a metallic material selected from a group consisting of Al, Cu, and Mn;
providing a liquid crystal polymer;
combining said metallic material and liquid crystal polymer into a mixture;
extruding said mixture into a plurality of plastic tubes, wherein each of said plastic tubes include an opened end adapted to be insert into one of said slots;
inserting said plastic tubes into corresponding said slots of said plastic tank;
assembling said convoluted metallic fins between said plastic tubes; and
applying a thermoplastic adhesive having an ionomer onto mating surfaces of said metal fins and said plastic tubes, and onto mating surfaces of said slots and said plastic tubes; and
heating the assembly with infrared radiation to the 400° F. to cure said thermoplastic adhesive, thereby bonding said metal fins and said slotted headers to said tubes.
